(19) United States
(12) Patent Application Publication
(10) Pub. No.: US 2019/0012750 A1
(43) Pub. Date: Jan. 10, 2019

(54) ENERGY PERFORMANCE EVALUATION METHOD AND DEVICE

(71) Applicant: PHILIPS LIGHTING HOLDING B.V., EINDHOVEN (NL)

(72) Inventors: DAVID RICARDO CAICEDO FERNANDEZ, EINDHOVEN (NL); ASHISH VIJAY PANDHARIPANDE, EINDHOVEN (NL)

(21) Appl. No.: 16/069,621

(22) PCT Filed: Jan. 2, 2017
(86) PCT No.: PCT/EP2017/050016

§ 371 Date: Jul. 12, 2018

(30) Foreign Application Priority Data
Jan. 12, 2016 (EP) 16150865.0

(51) Int. Cl. G06Q 50/06; G06F 1/32; H05B 37/02; G06N 99/00; H05B 33/08

(52) U.S. Cl. CPC G06Q 50/06; G06F 1/3234; H05B 33/0845; G06N 99/005; H05B 37/0218

(57) ABSTRACT

A method to evaluate energy performance of a second lighting system in a building. Training-data of a first lighting system in the building is obtained (310) and used to train (330, 340) an energy-use prediction model for the first lighting system from the training-data. Use-data of the second lighting system is obtained (410) in the building. Energy-use prediction-data is computed (450) by evaluating the energy-use prediction model for use-data and compared to energy-use use-data.

### FIELD OF THE INVENTION

The invention relates to a method to evaluate energy performance of a second lighting system in a building, an energy performance evaluation device, a computer program, and a computer readable medium.

### BACKGROUND

An important portion of electrical energy consumption in commercial buildings may be attributed to artificial lighting. Lighting energy consumption may be reduced by upgrading a building's lighting system to a more energy efficient lighting system, say upgrading conventional fluorescent lighting to more energy efficient light emitting diode (LED) lighting. Further energy savings may be obtained by incorporating or improving controls linked to occupancy conditions and daylight changes.

The increased complexity of lighting systems, especially those wherein control is based on multiple sensors, possibly complemented with additional manual control, makes verification of the energy gain difficult to determine.

For example, one may evaluate the energy performance of the upgraded lighting system by monitoring, say using energy meters, over a period of the pre-upgrade and then over a period of the post-upgrade. The energy improvement may then be estimated by the difference of the energy use before and after the upgrade.

Unfortunately, this approach turned out to lead to problems in practice. The energy consumption of lighting systems is known to vary widely depending on aspects like daylight variations, and occupancy conditions. There can be a wide variation in these factors across the pre- and post-upgrade periods. The lighting system may be under completely different operating conditions across the two time periods resulting in a poor estimation of energy savings. Ideally, one desires a comparison of energy consumption of the pre-upgrade and post-upgrade lighting systems under the same operating conditions.

For example, if the pre-upgrade period is 3 months of winter followed by a post-upgrade period of 3 months of spring, then the energy performance will likely show an improvement. It is however difficult say which part of the energy performance is due to the upgrade and which part is due to different light conditions in different seasons. Furthermore, the upgraded system may require tuning to fully realize the energy savings which is obscured by the fact that the circumstances have changed. This problem has hampered effective upgrading of lighting networks, as it is difficult to verify if the upgraded system is operating as it should or if something is amiss.

A similar problem is seen in maintenance of lighting systems. Modern lighting systems may depend on many different controls. Changes in the environment may have considerable impact on the energy use. Accordingly, if the energy is increased from one period to the next, say from one month to the next, it is difficult to say if the energy increase is due to a problem, e.g., a malfunctioning unit, a mis-configuration etc., or due to differing circumstances.

### SUMMARY OF THE INVENTION

A method to estimate energy performance of a second lighting system in a building compared to a first lighting system in the building is presented. The method comprises:
obtaining training-data of the first lighting system in the building, the training-data being obtained from using the first lighting system in the building over a training period, the training-data comprising:
energy-use training-data indicating the energy-use of the first lighting system, and
at least one of: occupancy training-data obtained from occupancy sensors in the building, the occupancy training-data at least indicating the presence or absence of a user at multiple locations in the building, and daylight level training-data obtained from light sensors in the building, the daylight level training-data indicating an amount of incident daylight at multiple locations in the building, and
training an energy-use prediction model for the first lighting system from the training-data,
obtaining use-data of the second lighting system in the building, the use-data being obtained from using the second lighting system in the building over a use period, the use period being after the training period, the use-data comprising:
energy-use use-data indicating the energy-use of the second lighting system, and
at least one of: occupancy use-data obtained from occupancy sensors in the building, the occupancy use-data at least indicating the presence or absence of a user at the multiple locations in the building, and daylight level use-data obtained from light sensors in the building, the daylight level use-data indicating an amount of incident daylight at the multiple locations in the building, and
computing energy-use prediction-data by evaluating the energy-use prediction model for the occupancy use-data and/or daylight level use-data, and
estimating the energy performance of the second lighting system compared to the first lighting system by comparing the energy-use use-data with the energy-use prediction-data.

By comparing the energy use of the second lighting system with a prediction of the energy use of the first lighting system energy performance problems may be found.

Such problems may occur both when the first lighting system is replaced, and when the same lighting network continued to be used. Thus the energy performance of a second lighting system is evaluated with respect to a first lighting system, even though the first lighting system may no longer be available at the time the comparison is made.

Also an energy performance evaluation device is presented that may be used to compare the predicted energy use of a first light system with the actual energy use of a second light network. The energy performance evaluation device is an electronic device. For example, the device may comprise a computer.

A method according to the invention may be implemented on a computer as a computer implemented method, or in dedicated hardware, or in a combination of both.

Executable code for a method according to the invention may be stored on a computer program product. Examples of computer program products include memory devices, optical storage devices, integrated circuits, servers, online software, etc. Preferably, the computer program product comprises non-transitory program code stored on a computer readable medium for performing a method according to the invention when said program product is executed on a computer.

In a preferred embodiment, the computer program comprises computer program code adapted to perform all the steps of a method according to the invention when the computer program is run on a computer. Preferably, the computer program is embodied on a computer readable medium. Another aspect of the invention provides a method of making the computer program available for downloading.

The invention further relates to an energy performance evaluation device arranged to estimate the energy performance of a second lighting system in a building compared to a first lighting system in the building, the energy performance evaluation device comprising:
a training interface arranged to obtain training-data of the first lighting system in the building, the training-data being obtained from using the first lighting system in the building over a training period, the training-data comprising:
energy-use training-data indicating the energy-use of the first lighting system, and
at least one of: occupancy training-data obtained from occupancy sensors in the building, the occupancy training-data at least indicating the presence or absence of a user at multiple locations in the building, and daylight level training-data obtained from light sensors in the building, the daylight level training-data indicating an amount of incident daylight at multiple locations in the building, and
a machine learning unit arranged to train an energy-use prediction model for the first lighting system from the training-data,
a use interface arranged to obtain use-data of the second lighting system in the building, the use-data being obtained from using the second lighting system in the building over a use period, the use period being after the training period, the use-data comprising:
energy-use use-data indicating the energy-use of the second lighting system, and
at least one of: occupancy use-data obtained from occupancy sensors in the building, the occupancy use-data at least indicating the presence or absence of a user at the multiple locations in the building, and daylight level use-data obtained from light sensors in the building, the daylight level use-data indicating an amount of incident daylight at the multiple locations in the building, and
an energy-use prediction unit arranged to compute energy-use prediction-data by evaluating the energy-use prediction model for the occupancy use-data and/or the daylight level use-data, and
an evaluating unit arranged to estimate the energy performance of the second lighting system compared to the first lighting system by comparing the energy-use use-data with the energy-use prediction-data.

The invention further relates to a second lighting system comprising
multiple occupancy sensors arranged to obtain occupancy use-data, the occupancy use-data at least indicating the presence or absence of a user at multiple locations in the building, and/or
multiple daylight sensors arranged to obtain daylight level use-data, the daylight level use-data indicating an amount of incident daylight at the multiple locations in the building, and
an energy-use unit arranged to obtain energy-use use-data indicating the energy-use of the second lighting system, and
the energy performance evaluation device according to the invention.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings,

FIG. 1a schematically shows an example of an embodiment of a lighting system,

FIG. 1b schematically shows an example of an embodiment of a luminaire,

FIG. 1c schematically shows an example of an embodiment of a lighting system control,

FIG. 2 schematically shows an example of an embodiment of an energy performance evaluation device,

FIG. 3 schematically shows an example of a method 300 of training an energy-use prediction model,

FIG. 4 schematically shows an example of a method 400 of evaluating energy performance,

FIG. 5 illustrates training of an embodiment of a prediction model,

FIGS. 6a-6d show graphs illustrating embodiments of the method.

FIG. 7a schematically shows a computer readable medium having a writable part comprising a computer program according to an embodiment,

FIG. 7b schematically shows a representation of a processor system according to an embodiment.

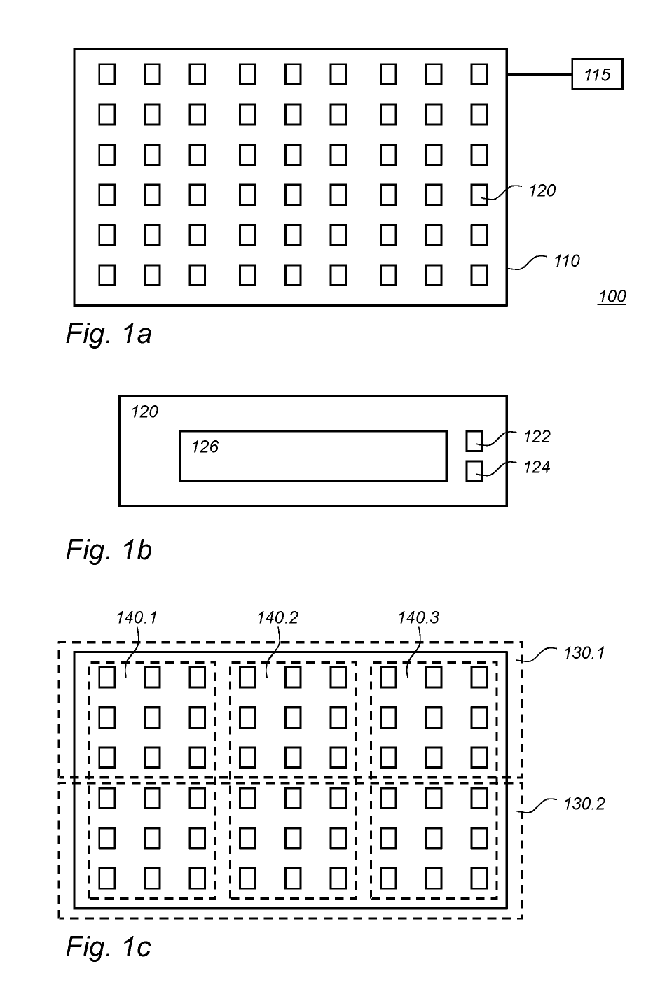

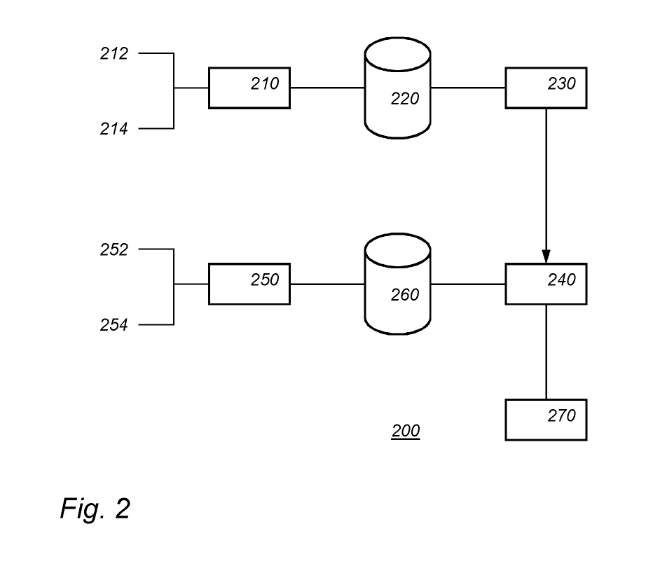

### LIST OF REFERENCE NUMERALS IN FIGS. 1a-2:

100 a lighting system
110 an office area
115 a lighting system controller
120 a luminaire
122 an occupancy sensor
124 a light sensor
126 a lighting element
130.1, 130.2 a daylight area
140.1, 140.2, 140.3 an occupancy area
200 an energy performance evaluation device
210 a training interface
212 sensor inputs
214 energy use inputs
220, 260 a database
230 a machine learning unit
240 an energy-use prediction unit
250 a use interface
252 sensor inputs
254 energy use inputs
270 an evaluating unit

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described above or recited in mutually different dependent claims.

Embodiments of the invention achieve a better estimate of the energy performance, e.g., energy savings, due to an upgrade in the lighting control system. Embodiments of the invention achieve a better monitoring of the energy performance of a network, to see, e.g., if energy use deteriorates pointing, say, to a problem in the lighting network.

In an embodiment of the method, a relationship between collected inputs (daylight level and/or occupancy states) and energy consumption of the lighting system in the pre-upgrade period is determined; for example uses support vector regression techniques. Using this relationship and collected inputs in the post-upgrade period of the lighting system, an estimation of the energy savings due to the upgrade is obtained. The performance of the proposed method can then be evaluated by comparing predicted, e.g. simulated, data to actual energy use. If it turns out that the upgraded network does not achieve an energy use improvement or if the energy use of a network deteriorates compared to predicted energy use, a problem is found. The problem may be a faulty light unit, a mis-configuration and the like. Thus even if circumstances change, e.g., different daylight due to different seasons, two lighting systems may still usefully be compared, thus approaching closer the ideal of comparing energy consumption of the pre-upgrade and post-upgrade lighting systems under the same operating conditions.

Different methods for measurement and verification may be based on statistical sampling or on extensive energy monitoring. The former method is inaccurate, while the latter method requires time and is expensive. The latter method can still be inaccurate since it provides a time snapshot of the energy performance. Moreover, it cannot compensate for different daylight conditions and/or usage patterns that may change over the two time windows of measurement.

Below we first discuss the situation for an upgrade of the lighting system.

FIG. 1a shows an office area 110 of a building 100. In the building a first lighting system is installed. For example, the first lighting system may comprise multiple luminaires, occupancy and light sensors are connected to a central area controller 115. The artificial light output of the lighting system can be adapted to local occupancy and daylight conditions, say, in order to save energy.

In the example shown in FIG. 1a there are N=54 luminaires arranged in a grid of 9 by 6. Each luminaire has an integrated light sensor and an occupancy sensor. There are 18 workspaces in the office. Office area 110 is only exemplifying; for example, there may be multiple office areas in a building, the number of luminaires may be larger or smaller than indicated, etc.

An example of a luminaire with integrated light sensor and occupancy sensor is given in FIG. 1b. FIG. 1b illustrates a luminaire 120 that may be used in office area 110. Luminaire 120 comprises a lighting element 126, e.g., an LED, an occupancy sensor 122 and a light sensor 124.

The occupancy sensors and/or light sensors may be situated at the ceiling. An occupancy sensor determines occupancy status over its field-of-view. A typical occupancy sensor may give only the one-bit information that either no people, or 1 or more people are present in the field of view. A more advanced occupancy sensor may give the number of people present in the field of view. The latter advanced occupancy sensor may be used in embodiments but is not required.

A light sensor may determine an illuminance level in the field of view of the sensor. In an embodiment, the light sensor determines only the daylight illuminance level; for example, by measuring only light in the daylight spectrum. Alternatively, the light sensor measures the ambient light level. In the latter case a disaggregation step may be performed later to obtain the daylight therefrom. A luminaire may allow multiple dimming levels; e.g. four or more dimming levels. For example, the luminaire may allow a reduction in measured lumen output of 0%, 25%, 50%, and 100%. More or fewer dimming levels are possible. We will refer to a luminaire with only an on or off state as having two dimming levels (0% and 100%).

For example, the illuminance, also referred to as light level, may be the total luminous flux incident on a surface, per unit area. Illuminance may be expressed in lux. The latter is not required, instead of a measurement in lux, another value indicative of the illuminance may be used. For example, illuminance may be expressed as a dimming level of a luminaire together with an indication of the type of luminaire from the dimming level and luminaire type the illuminance may be derived.

The occupancy sensors may be situated at first occupancy sensor locations in the building, the light sensors at first light sensor locations in the building. It is not needed that occupancy sensors and/or light sensors are integrated with a luminaire; for example, stand-alone sensors may be used.

In addition to sensors the light system may also include one or more control units arranged to receive input from a user. The user may influence and/or override the control of the luminaires through the control units. For example, the control units may be wall switches, etc.

The luminaires, occupancy, light sensors, and control units, may be connected through a network. The network may be a wired or a wireless network, such as WiFi or Zigbee. The luminaires, occupancy, and light sensors may be connected to a lighting system controller 115.

Lighting system controller 115 is arranged to control the luminaires in the first lighting system. For example, on the basis of the sensor inputs, user inputs, etc., and lighting rules stored at lighting system controller 115, the lighting system controller 115 determines which luminaires should be turned on or off, and possibly also the diming level.

For example, the sensors may generate measurements every T seconds and transmit the measurements to the lighting system controller 115. At each time instant, lighting system controller 115 determines the dimming level of the luminaires based on the sensor feedback using an underlying lighting control algorithm. In an embodiment, T=5 seconds. Larger or smaller values of T are possible. The sensor measurement periods and control periods may be independent, or different per sensor type, etc.

Lighting controller 115 may use various lighting control algorithm, also referred to as lighting rules, to control the luminaires. One possible algorithm is illustrated with respect to FIG. 1c.

The lighting system is divided into Z=3 occupancy areas 140.1, 140.2 and 140.3, also referred to as {R_{z}, z=1, . . . , Z} and U=2 daylight areas 130.1, 130.2, also referred to as {Dᵤ, u=1, . . . , U} shown in FIG. 1c. Each sensor belongs to a given occupancy and daylight area. The z-th occupancy area is declared as occupied if occupancy is detected at any of its associated occupancy sensors, otherwise it is declared as unoccupied. Local daylight adaptation is enabled in those sensors in the vicinity of the windows 130.1 (D₁) while it is disabled elsewhere 130.2 (D₂). A luminaire is turned on only if it is in an occupied occupancy area. A turned on luminaire in D₂ is turned on fully, but a turned on luminaire in D₁ is dimmed to such a level that a target illuminance level is reached taking into account incident day light.

Note that the above control program is only one of many possible lighting control algorithms. Lighting control algorithms are often proprietary information and may not be known in sufficient detail either to the owner of building 100 or to the person who upgrades the first lighting system to a second lighting system. The above lighting algorithm uses both occupancy and lighting data, however it is also possible to have a lighting algorithm that uses only one of occupancy and lighting data, or that uses additional information.

At some point it may be desired to upgrade the lighting system installed in building 100, e.g., in office area 110. That is the upgrade may go from a first lighting system, e.g., as shown in figure la to a second lighting system (not separately shown). As part of the upgrade luminaires may be added, removed and/or replaced. The lighting algorithm may be changed. The number of sensors may be changed, etc. The aim of the upgrade is that the energy use of the second lighting system is less than that of the first lighting system. Unfortunately, a direct comparison between the first and second lighting system is not possible, however, by training an energy-use prediction model the current energy consumption of the second lighting system may be compared to the predicted energy-use of the first lighting system. Also controller 115 may be upgraded.

FIG. 2 describes an energy performance evaluation device 200 that may be used to evaluate the energy performance of the second network.

Device 200 comprises a training interface 210 arranged to obtain training-data of a first lighting system in the building. The training-data is obtained from using the first lighting system in the building over a training period. For example, training interface 210 may receive the training data from lighting system controller 115. The training data comprises energy-use training-data.

The training period is sufficiently long to represent a number of different conditions in the training data. For example, the training period may be a few weeks or a few months. Interestingly, in an embodiment the training period is 3 months or shorter (say 91 days or less). Such a short training period at most includes parts of two seasons, and will thus miss at least two seasons. However, even if the training data does not include say multiple days of summer, the training data will likely include some lighter and darker periods. Similarly, even if the training days does not include a holiday period, the training period may include a few days with fewer people present in the building, say early in morning or in the weekend. In this way, it is possible to learn the response of the lighting system even though the training period is significantly shorter than a full year.

In an embodiment, the lighting system controller 115 collects and stores data from the associated lighting systems every Tₛ seconds, e.g., a sample period, in a back-end database, say in database 220. In practice, data may be buffered and then stored in the database; so, Tₛ≥T. The collected data may include: light levels at light sensors, occupancy states at occupancy sensors, dimming levels of luminaires, and energy consumption of the lighting system. More information, for example, the daylight levels at the light sensors may also be computed and stored.

In a pre-upgrade period, the lighting system is referred to as the first lighting system, having a lighting control configuration, hereafter also referred to as configuration-1 or CONF-1. This lighting control system is upgraded to a different, potentially more efficient, lighting control configuration, hereafter referred to as the second lighting system or also as configuration-2 or CONF-2. We are interested in determining the energy savings due to the upgrade.

For example, training interface 210 may receive energy-use training-data from energy use inputs 214.

The energy-use training-data indicates the energy-use of the first lighting system. Energy use may be expressed say in kilowatt-hour, or a similar unit of electricity use. The energy use may be a total energy use of the entire first lighting system at some point, or of multiple large parts thereof. The energy use may also be a vector indicating energy use per luminaire of the lighting system.

In an embodiment, energy-use data comprises the dimming level of multiple luminaires, e.g. each luminaire of the lighting system. From the dimming level the energy use may be computed by knowing the type of luminaire, e.g., from a relationship between the dimming level and energy use of a luminaire. The total amount of energy use of light system may be obtained by adding the energy use of the individual luminaires in the light system. For example, device 200 may be arranged to compute energy use data from dimming data.

The training data further comprises at least one of occupancy training-data and daylight level training-data. The occupancy training-data and/or daylight level training-data may be received from sensor inputs 212, e.g., from occupancy and/or light sensors. Also this part of the training data may be received from lighting system controller 115.

The occupancy training-data indicates the presence or absence of a user at multiple locations in the building. The daylight level training-data indicates an amount of incident daylight at multiple locations in the building.

The training data received at training interface 210 may comprise both occupancy and daylight level training-data, but this may not be necessary, e.g., if the first lighting system does not utilize both types of input. In this case sufficient results may be achieved from using only the used type of sensor data. However, even if the lighting algorithm of the first network does not use both types of data, it may still be useful to collect both types of sensor data if the lighting system also allows manual control of users. For example, a user may be more likely to turn on more light if day light is low, even if the first lighting system itself does not use light sensors directly.

The training data may comprise additional information. For example, additional information may be selected from the group: light spectrum, color temperature, user locations, user light preferences, blind positions, temperature, weather conditions, etc. Corresponding sensors may be used or installed to measure one or more of these additional information. The additional information may help to better predict the response of the first lighting system to environmental conditions. Especially, if the first lighting system may be overruled by users, e.g., through user controls, such as wall switches, consoles, and the like, additional information may be useful.

In an embodiment, the daylight level training-data may directly contain daylight levels, e.g., by using daylight sensors. In an embodiment, the daylight level training-data comprises ambient light levels. Ambient light levels may be converted to daylight levels.

In an embodiment, device 200 comprises a database 220 arranged to store training data. In an embodiment, device 200 is arranged for a data reduction step of the training data to reduce the size of the training data.

Device 200 further comprises a machine learning unit 230 arranged to train an energy-use prediction model for the first lighting system from the training-data. The energy-use prediction model may be stored in an electronic storage (not separately shown in FIG. 2). There exists a number of prediction models and corresponding training algorithms to train a model. For example, machine learning unit 230 may use a support vector machine (SVM), e.g., using support vector regression, e.g., a multiclass support vector machine. Alternative supervised and semi-supervised learning algorithms may be used, e.g., neural networks.

The energy-use prediction model predicts energy use on the basis of the occupancy and/or daylight levels. Part of the training data may be used for validation of the model instead of training.

Once the energy-use prediction model has been trained, the training data stored in database 220 may be discarded. Once the model has been trained, the first lighting system may be upgraded to a second lighting system.

Device 200 further comprises a use interface 250 arranged to obtain use-data of the second lighting system in the building, the use-data being obtained from using the second lighting system in the building over a use period, the use period being after the training period. The use period may be a period in which the energy performance of the second lighting system is evaluated. The use period may both be shorter or longer than the first period.

The inputs of the user interface 250 are similar to the inputs of training interface 210. The user interface 250 may also receive data from sensor inputs 252 and energy use inputs 254. For example, the use-data comprises energy-use use-data indicating the energy-use of the second lighting system, and at least one of: occupancy use-data at least indicating the presence or absence of a user at the multiple locations in the building, and daylight level use-data indicating an amount of incident daylight at the multiple locations in the building.

The use-data generally contain the same number and type of data items as the training-data as the use-data is to be used by a model that was trained on the trained data. For example, in an embodiment, the use-data comprises the same type of light, occupancy, and/or additional data as the training data. This is not strictly necessary though. For example, during the training phase ambient light sensors may be used, from which day light levels are computed (disaggregated) during the use phase day light sensors may be used which do not require a disaggregation. In the latter case a calibration phase may be used to validate the output of the ambient and daylight sensors.

Use data may be stored in database 260. For example, database 260 may be used to buffer the use data so that batched evaluating is possible. Alternatively, the use data is immediately processed, and only the actual and predicted energy use is kept, say in database 260 or elsewhere. Databases 220 and 260 may share the same storage.

Training interface 210 and use interface 250 may be implemented as a protocol over a data network; they may use the TCP/IP protocol, etc.

Device 200 comprises an energy-use prediction unit 240 arranged to compute energy-use prediction-data by evaluating the energy-use prediction model for the occupancy use-data and/or the daylight level use-data. For example, energy-use prediction unit 240 uses the occupancy use-data and/or the daylight level use-data obtained from use interface 250 and present it to the model. The model responds with an estimated energy use of the first energy network. This allows a comparison to be made between the current (second) lighting system and the previous (first) lighting system.

Device 200 comprises an evaluating unit 270 arranged to evaluate the energy performance of the second lighting system by comparing the energy-use use-data with the energy-use prediction-data. Evaluating unit 270 obtain the actual energy use in the use period and the predicted energy use in the use period and compares the values. If energy use is reported per luminaire, the evaluating unit 270 may computed the total energy use for comparison purposes. Evaluating unit 270 may also compute the average actual and predicted energy use over the use period. In an embodiment, the device may be used to compute accrued savings in utility costs.

Device 200 comprises two main parts. A first part is used during the training period, comprising the interface 210, database 220, and machine learning unit 230. A second part is used during the use period and comprises interface 250, database 260, prediction unit 240, and evaluating unit 270. The first and second part may also be implemented as separate devices: a first device arranged for the first part, arranged for training an energy-use prediction model and a second device arranged for the second part, arranged for evaluating energy performance which uses the energy-use prediction model. The second device may comprise a storage for storing the model.

A mathematical description of an embodiment device 200 is presented below. Below we refer to a first lighting system as ‘CONF-1’ and the second lighting system as ‘CONF-2’. A first lighting system, say a lighting system such a depicted in Fig. la can be abstractly represented wherein the energy consumption (E) of the lighting system under CONF-1 at time instant j is a function (h) of daylight levels (s) and occupancy states (o), i.e.,

E(j)≈h⁽¹⁾{o(j),s(j)},

o(j)=[o₁(j),. . . ,o_{N}(j]^{T} and

s(j)=[s₁(j, . . . ,s_{N}(j)]^{T}.

Here, sₙ(j)≥0 and oₙ(j)∈{0,1} are respectively the daylight contribution and the occupancy status at occupancy sensor n at time instant j. If the n -th occupancy sensor detects occupancy within its field of view at time instant j, then oₙ(j)=1, otherwise oₙ(j)=0 . The term E(j) is the energy consumption of the lighting system at time instant j during the previous T seconds. Note that the energy consumption may be measured or estimated from the dimming levels of the luminaires of the lighting system.

To estimate the average energy consumption per day of the lighting system under CONF-1 during a time period W2, \tilde{E}_{W2}^{CONF-1}. An embodiment comprises of two phases: (i) training phase (employed in the pre-upgrade period) and (ii) estimation phase (employed in the post-upgrade period).

During the training phase, the lighting system is under CONF-1 and the following data is collected: (i) daylight levels, (ii) occupancy states and (iii) energy consumption. Using the collected data, an estimate it \tilde{h}⁽¹⁾{⋅} of the function h⁽¹⁾{⋅} is obtained.

After the training phase, the lighting system has been upgraded to CONF-2. Using the daylight levels and occupancy states obtained at time period W2 and the previously estimated function \tilde{h}⁽¹⁾{⋅}, an estimate of the average energy consumption per day of the lighting system under CONF-1 during time period W2 is obtained, \tilde{E}_{W2}^{CONF-1}.

Let S be the data set collected during the training phase with p-th entry given by {sₚ,oₚ,Eₚ} where sₚ=[s_{1,p} . . . s_{N,p}]^{T}, oₚ=[o_{1,p} . . . o_{N,p}]^{T} and Eₚ are respectively the daylight levels, occupancy states and energy consumption of the lighting system under CONF-1.

The p-th entry in the data set S may be pre-processed to obtain an input vector xₚ=fₓ{sₚ, oₚ} and output yₚ=f_{y}{Eₚ} where fₓ{ } is a function that provides F relevant features of the lighting system and f_{y}{ } is a normalization of the energy consumption of the lighting system. The data set is split into a training data set, T, and a validation data set, V.

During the training phase, we are interested in finding a function h{x} that approximates the output yₚ within a deviation ε≥0 and thus \tilde{h}⁽¹⁾{x}=f_{y}⁻¹{h{x}}. Using the framework of support vector regression, this function may be given by

$$h \{ x \} = {\sum }_{p ∈ T} ( {α}_{p} - {α}_{p}^{*} ) K \{ {x}_{p} , x \} + b ,$$

where K{⋅,⋅} is a kernel function. In an embodiment, we choose a radial basis function (RBF) kernel with weighted features given by

K{x,x′}=exp(−λPΓ(x−x′)P₂²),

where λ>0 is a tuning parameter, T is a diagonal matrix with entry [Γ]_{v,v} equal to the assigned weight of the v-th feature. A feature with a larger weight is more relevant for the classification than a feature with a lower weight. The bias term b is given by

$$b = \frac{1}{\vert {T}^{′} \vert} {\sum }_{n ∈ {T}^{′}} ( {y}_{n} - {\sum }_{p ∈ T} ( {α}_{p} - {a}_{p}^{*} ) K \{ {x}_{p} , {x}_{n} \} )$$

where T′={n:0<αₙ<C and0<αₙ*<Candn∈T}. The weights {αₚ} and {αₚ*} may be obtained as the solution to

$$arg {min}_{\{ {α}_{n} \} , \{ {α}_{n}^{*} \}} \frac{1}{2} {\sum }_{{m ∈ T}_{n ∈ T}} ( {α}_{m} - {α}_{m}^{*} ) ( {α}_{n} - {α}_{n}^{*} ) K \{ {x}_{m} , {x}_{n} \} + {\sum }_{p ∈ T} {α}_{p} ( - {y}_{p} + ɛ ) + {α}_{p}^{*} ( {y}_{p} + ɛ ) \\ s . t . \{ \begin{matrix}{\sum }_{p ∈ T} ( {α}_{p} - {α}_{p}^{*} ) = 0 , \\ 0 \leq {α}_{p} \leq C , p ∈ T , \\ 0 \leq {α}_{p}^{*} \leq C , p ∈ T ,\end{matrix} \qquad ( 4 )$$

where C is a regularization parameter. The parameters C and λ may be chosen such that the error in the validation set V is minimized.

Let Q be the data set collected during an estimation phase following the training phase, with q-th entry given by {s_{q}, o_{q}} where s_{q}=[s_{1,q} . . . s_{N,q}]^{T} and o_{q}=[o_{1,q} . . . o_{N,q}]^{T} are respectively the daylight levels and occupancy states of the lighting system under CONF-2.

The q-th entry in the data set Q is pre-processed to obtain an input vector \hat{x}_{q}=fₓ{s_{q},o_{q}}. Using the previously obtained trained function, we estimate the corresponding output for the q -th entry as

$${\tilde{y}}_{q} = h \{ {\hat{x}}_{q} \} = {\sum }_{p ∈ T} ( {α}_{p} - {α}_{p}^{*} ) K \{ {x}_{p} , {\hat{x}}_{q} \} + b . \qquad ( 5 )$$

The average energy consumption per day is thus given by

$${\tilde{E}}_{W 2}^{CONF - 1} = \frac{{Q}_{d}}{Q} {\sum }_{q ∈ Q} {f}_{y}^{- 1} \{ {\tilde{y}}_{q} \} . \qquad ( 6 )$$

where Q is the number of entries in data set Q and Q_{d} is the number of entries per day.

By comparing the estimated average energy consumption per day with the actual average energy consumption per day malfunction of the second lighting system (CONF-2) may be found.

Above, embodiments are described in which the first lighting system is replaced by a second lighting system. This allows malfunction and/or mal-configuration to be found in the in the second lighting system. Often the second lighting system is supposed to be more energy efficient than the previous first lighting system. If the use period happens to be a period with lots of day light or with relatively low occupancy whereas the training period happened to be a period with relatively little day light or with relatively high occupancy rates the second lighting system may actually use less energy. However, in cases like this comparing actual energy use does not accurately show if the second lighting system is more energy efficient.

For example, evaluating unit 270 may be arranged to generate a signal if the energy-use use-data is more than the energy-use prediction-data. In an embodiment, a signal may be generated if the energy-use use-data is more than a factor times the energy-use prediction-data. The factor may be less than 1, say 0.9 (90%). The factor may be chosen depending on the circumstances; for example, a higher factor may be chosen if the first lighting system is of a higher energy efficiency, and less energy efficiency gains are expected.

This signal may be followed up by personal to investigate why the second lighting system appears to be less energy efficient than the first lighting network would have been.

Embodiments of the invention may also be used if the network has not been upgraded. For example, in an embodiment, the first and second lighting systems are the same lighting system. The model may be trained in a training period. The trained model may be used in the use period to compare the lighting system with the same lighting system but in a previous period. This use of an embodiment of energy performance evaluation allows malfunction causing decreased energy efficiency to be found relatively easily. It may be detected that based on past performance a lower energy use is predicted than what is observed. For example, in an embodiment, the evaluating unit 270 may be arranged to generate a signal if the energy-use use-data differs from the energy-use prediction-data by more than a threshold.

In an embodiment, the occupancy training-data is obtained from occupancy sensors at first occupancy sensor locations in the building, the occupancy use-data is obtained from occupancy sensors at second occupancy sensor locations in the building, the first occupancy sensor locations being a subset of the second occupancy sensor locations.

In an embodiment, the daylight level training-data is obtained from light sensors at first light sensor locations in the building, the daylight level use-data is obtained from light sensors at second light sensor locations in the building, the first light sensor locations being a subset of the second light sensor locations.

It was found that the energy predictions are more reliable if the same type of sensor measurements are used, e.g., at the same locations. Even if the second lighting system comprises more sensors than the first lighting system did, the model may use a subset of the new sensors for making predictions. The full set of sensors may be used to control lighting in the second lighting system.

Interestingly, in an embodiment, new occupancy and/or lighting sensors are installed before the training period. During the training period the new sensors are used for generating training data and training the model. After the training period also the luminaires are changed. The old occupancy and/or lighting sensors are then removed. Even if the proprietary system of the first lighting system uses the old sensors, the new sensors may be still be used to predict the energy use of the first lighting system.

In an embodiment, a set of training sensors are installed before the training period. The training sensors may include light and occupancy sensors. The training sensors are used to obtain the training data and the use data. The training sensors are not used to control the first or second lighting network but are only present for comparison purposes. After the use period the training sensors may be removed. Additional sensors may be installed together with the second lighting system to control the second lighting system. Using training sensors has the advantage that it no access is required to sensor data in a proprietary system. Furthermore, the location of the training sensors is not bound either to the locations of the sensors in the first lighting system or to the location of the sensors in the second lighting system.

In an embodiment, the lighting sensors used in the training and/or use period do not measure day light levels directly but ambient light levels. Device 200 may be arranged to disaggregate the received ambient light training-data and/or use-data to obtain the daylight level training-data and/or the daylight level use-data. For example, using the dimming levels of a luminaire the light output of a luminaire may be computed and subtracted from the measured ambient light levels. Typically, the device 200 comprises a microprocessor (not separately shown in FIG. 2) which executes appropriate software stored at the device 200; for example, that software may have been downloaded and/or stored in a corresponding memory, e.g., a volatile memory such as RAM or a non-volatile memory such as Flash (not separately shown). Alternatively, the device 200 may, in whole or in part, be implemented in programmable logic, e.g., as field-programmable gate array (FPGA). Device 200 may be implemented, in whole or in part, as a so-called application-specific integrated circuit (ASIC), i.e. an integrated circuit (IC) customized for their particular use. For example, the circuits may be implemented in CMOS, e.g., using a hardware description language such as Verilog, VHDL etc.

In an embodiment, device 200 comprises a training interface circuit, a machine learning circuit, a use interface circuit, an energy-use prediction circuit, and an evaluating circuit, etc. The circuits implement the corresponding units described herein. The circuits may be a processor circuit and storage circuit, the processor circuit executing instructions represented electronically in the storage circuits. The circuits may also be, FPGA, ASIC or the like.

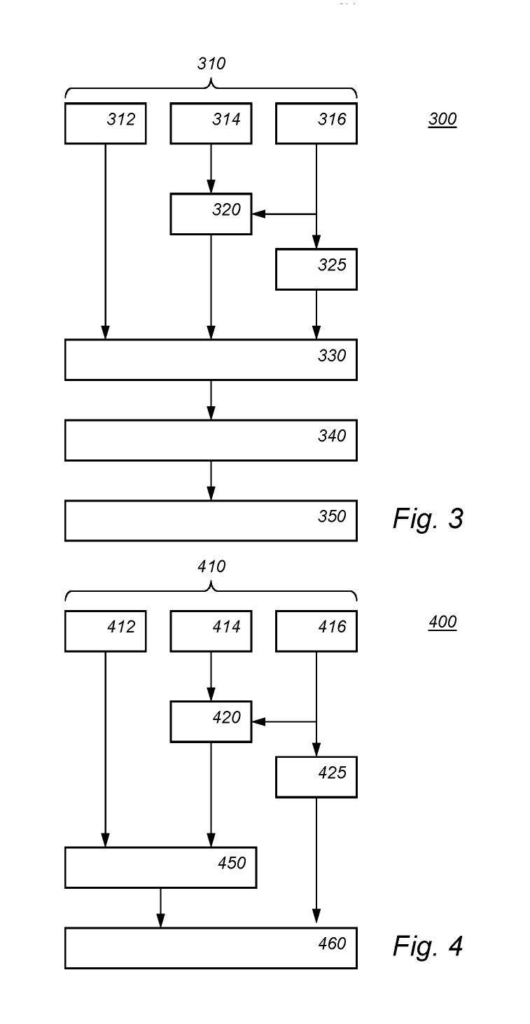

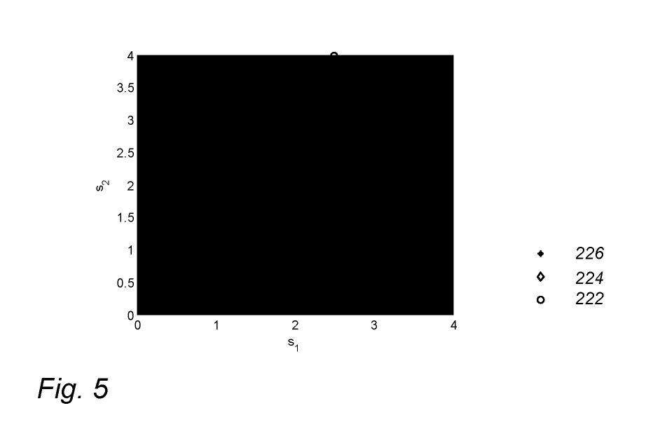

FIG. 3 schematically illustrates an example of a method 300 of training an energy-use prediction model. FIG. 4 schematically illustrates an example of a method 400 of evaluating energy performance which uses the energy-use prediction model.

Method 300 comprises obtaining 310 training-data of the first lighting system in the building. The training-data is obtained while using the first lighting system in the building over a training period. The training period may be, say, a month, 3 months, etc.

In this exemplifying embodiment, the training-data comprising energy-use training-data 316 indicating the energy-use of the first lighting system, occupancy training-data 312 at least indicating the presence or absence of a user at multiple locations in the building, and daylight level training-data 314 indicating an amount of incident daylight at multiple locations in the building.

In this embodiment, the energy use is give in the form of dimming levels of luminaires and the daylight level training-data 314 comprises ambient light levels. Method 300 comprises disaggregating 320 the ambient light data to obtain daylight data. Disaggregating 320 may use dimming levels 316. From the dimming levels 316 the energy consumption is derived 325. The latter may be the total energy consumption over the past sample period, say the past 5 seconds. Energy consumption may be given in a unit of energy per a time unit, etc.

Method 300 comprises training an energy-use prediction model for the first lighting system from the training-data. For example, the method 300 may comprises a training data preparation step 330 before the actual machine learning algorithm 340. For example, the preparation 330 may include collection of training data and option clustering or filtering of the training data. The end result of method 300 is a predictive model (E₁) shown in box 350. For example, a device, say device 200 may comprise a processor and memory arranged to execute training the energy-use prediction model. The energy-use prediction model may be stored in memory, say in the form of a series of coefficients.

For example, in the optional preparation 330 each training examples may be assigned to an energy use category. For example, multiple classes energy uses may be used. Multiple energy classes may be obtained by determining the maximum energy use in a period and dividing this number by the number of desired classes. The number of desired classes may be say 10, or more or less. A set of day light sensor information, occupancy information and an energy use class over a sample period may be used as a training example. Not all training algorithms require a classification preparation.

Method 400 comprises obtaining 410 use-data of the second lighting system in the building, the use-data being obtained from using the second lighting system in the building over a use period, the use period being after the training period, the use-data comprising:
energy-use use-data 416 indicating the energy-use of the second lighting system, and
at least one of: occupancy use-data 412 at least indicating the presence or absence of a user at the multiple locations in the building, and daylight level use-data 414 indicating an amount of incident daylight at the multiple locations in the building.

For example, daylight level use-data 414 may be sensor data obtained from a light sensor, in particular an ambient light sensor. Energy-use training-data 416 may be dimming levels of luminaries. Method 400 comprises disaggregating 420 the ambient light data to obtain daylight data. Disaggregating 420 may use dimming levels 416. From the dimming levels 416 the energy consumption is derived 425.

Note that counterintuitively the dimming levels, and thus indirectly the actual energy consumption of the second lighting system is used in preparing data which aims to predict the energy consumption of the first lighting system.

Method 400 comprises computing energy-use prediction-data 450 by evaluating the energy-use prediction model for the occupancy use-data and/or daylight level use-data, and

evaluating 460 the energy performance of the second lighting system by comparing the energy-use use-data with the energy-use prediction-data.

In an embodiment, the method comprises two phases: (i) training phase 300 and (ii) operational phase 400. During the training phase, the lighting system is using configuration-1. The central processing unit collects lighting data from sensors (e.g.

occupancy status and daylight levels) and energy consumption (e.g. dimming levels) into a database. At time instant k, the occupancy status may be given by vector o(k); the daylight levels may be given by vector s(k); and dimming levels may be given by vector d(k). Using this data and machine learning algorithms (e.g. Multiclass SVM), a predictive model for the energy consumption under configuration-1 is generated. During the operational phase (configuration-2), such predictive model is applied to new lighting data from sensors (occupancy status/daylight levels) in order to extrapolate the energy consumption of configuration-1 while configuration-2 is operational.

In an embodiment, configuration-1 is different from configuration-2. As an example, we consider an upgraded lighting control system (with granular daylight and occupancy control: configuration-2) with respect to the existing lighting control system (with only granular daylight control: configuration-1).

During training phase (configuration-1), daylight vectors s(k) and corresponding energy consumption e(k) are collected.

Vectors s(k) are clustered based on predefined ranges of energy consumption {eᵢ}.

A predictive model that classifies each vector s(k) into a given cluster {eᵢ} is determined.

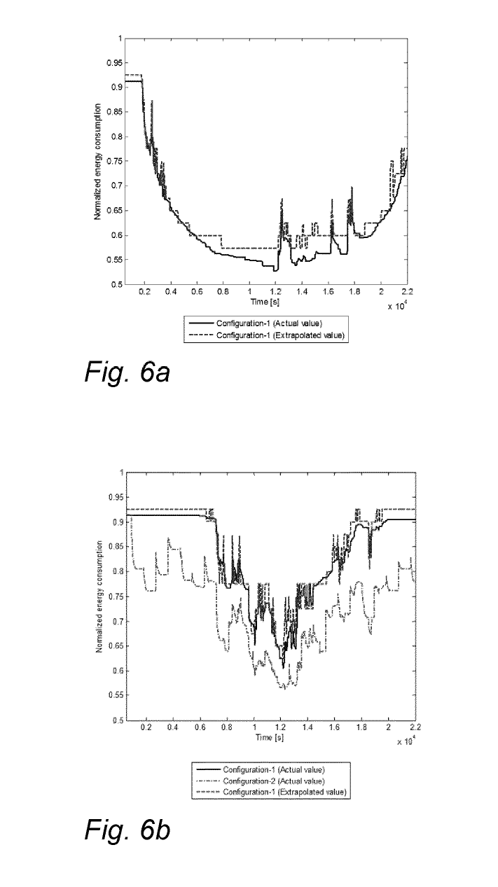

FIG. 5 shows an illustration in which an example with daylight measurements from two sensors s(k)=[s₁ s₂]. In embodiments, the number of sensors may be significantly larger. The two axes each represent a light sensor, in this illustration no occupancy information is used. The points marked 226 correspond to an energy consumption of 60 or more. The points marked 224 correspond to an energy consumption between 30 and 60. The points marked 222 correspond to an energy consumption of below 30. An SVM machine learning algorithm has clustered the data into three regions, marked 212, 214 and 216. Region 212 corresponds predominately with energy use 222; region 214 with energy use 224; and region 216 with energy use 226. From this clustering energy use may be predicted. If the two daylight sensors are known it may be derived in which region the corresponding point lies, and a corresponding energy use may be estimated therefrom. For example, during operational phase (configuration-2), new daylight vectors s(k) are collected and the predicted energy consumption of configuration-1 is obtained.

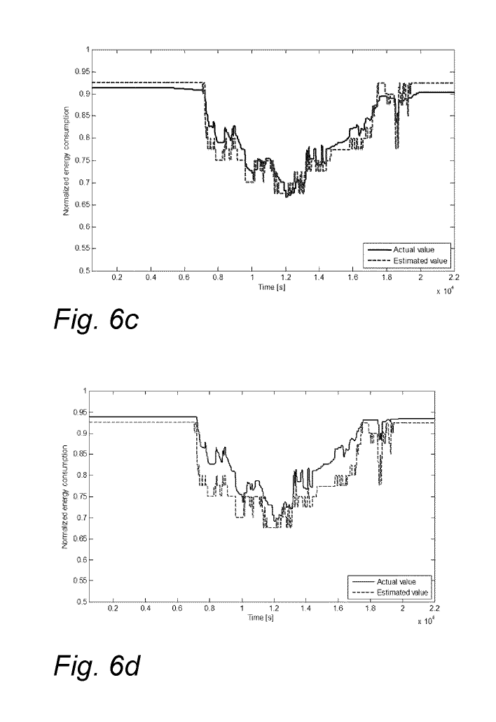

In FIG. 6a, the actual energy consumption for the training phase (a day in September) is shown. The predicted energy using the determined predictive model is also shown. Note, both the actual value of the first lighting system and the predicted energy use of the second lighting system is shown for the same day. In this case the model is used to predict the energy use of the first lighting system. Thus FIG. 6a gives an indication of the accuracy of the model.

During operation mode, the upgraded smart lighting system (configuration-2) is enabled and the energy consumption of configuration-1 is extrapolated for each new day (a day in December). FIG. 6b shows both the actual configuration 1 data (using an accurate simulation of configuration 1 using the actual light algorithm of configuration 1), the predicted configuration 1 data (using the trained model) and the actual configuration 2 data. Note that the actual and predicted values of the first configuration closely match each other. Moreover, the actual energy use of the second lighting network is well below both the actual and predicted energy use of the first configuration. This shows that comparing the energy use of the second lighting system may indeed be compared with the predicted energy use of the first lighting system. Also note that the graph of energy use in September and in December looks quite different.

The normalized daily energy consumptions are E₁(W₁)=0.64, E₁(W₂)=0.84, E₂(W₂)=0.73. The extrapolated normalized daily energy consumption is Ê₁(W₂)=0.85. Using a traditional method for calculating energy savings we obtain E₁(W₁)−E₂(W₂)=−0.09 (no energy savings), or a 12% loss. In comparison, using the proposed method we obtain Ê₁(W₂)−E₂(W₂)=0.12 (a 16% gain in savings) which is closer to the actual value E₁(W₂)−E₂(W₂)=0.11.

Note that the configuration-1 lighting system may come from a different vendor than configuration-2 and its algorithm/behavior may not be known a-priori.

In an embodiment, configuration-1 is the same as configuration-2. For example, it may be desired that the performance of a lighting system is maintained. Energy consumption may be used as a performance indicator of the lighting system. A variation between the expected and actual energy consumption is indicative of a problem that might need to be resolved (e.g. diminishing light output of the luminaires). In FIG. 6c, the extrapolated and actual energy consumptions of the lighting system are shown under normal output of the luminaires. Note that these are quite close. In comparison, in FIG. 6d, the extrapolated and actual energy consumptions of a lighting system are shown that has a decreased output of the luminaires. Note that the actual value is well above the estimated value.

Many different ways of executing embodiment of methods are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method.

A method according to the invention may be executed using software, which comprises instructions for causing a processor system to perform method 300 and 400. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. A method according to the invention may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

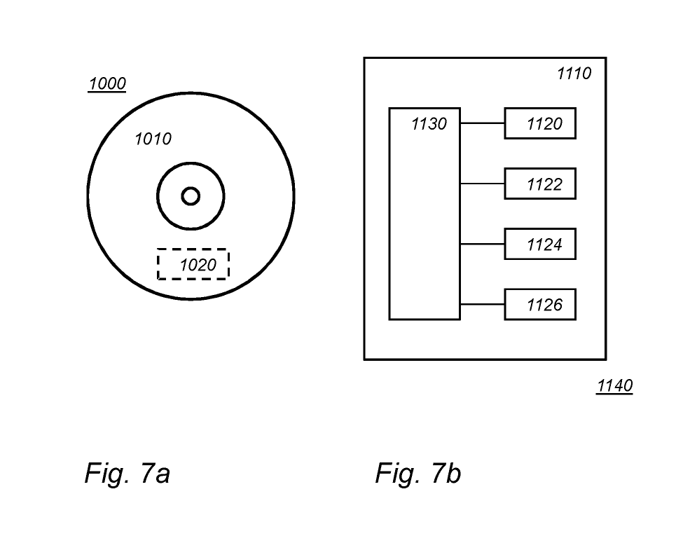

FIG. 7a shows a computer readable medium 1000 having a writable part 1010 comprising a computer program 1020, the computer program 1020 comprising instructions for causing a processor system to perform a method to evaluate energy performance of a second lighting system, according to an embodiment. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said method to evaluate energy performance of a second lighting system.

FIG. 7b shows in a schematic representation of a processor system 1140 according to an embodiment. The processor system comprises one or more integrated circuits 1110. The architecture of the one or more integrated circuits 1110 is schematically shown in FIG. 7b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In the claims references in parentheses refer to reference signs in drawings of embodiments or to formulas of embodiments, thus increasing the intelligibility of the claim. These references shall not be construed as limiting the claim.

1. A method to estimate energy performance of a second lighting system in a building compared to a first lighting system in the building, the method comprising:
obtaining training-data of the first lighting system in the building, the training-data being obtained from using the first lighting system in the building over a training period, the training-data comprising:
energy-use training-data indicating the energy-use of the first lighting system, and
at least one of: occupancy training-data obtained from occupancy sensors in the building, the occupancy training-data at least indicating the presence or absence of a user at multiple locations in the building, and daylight level training-data obtained from light sensors in the building, the daylight level training-data indicating an amount of incident daylight at multiple locations in the building, and
training an energy-use prediction model for the first lighting system from the training-data,
obtaining use-data of the second lighting system in the building, the use-data being obtained from using the second lighting system in the building over a use period, the use period being after the training period, the use-data comprising:
energy-use use-data indicating the energy-use of the second lighting system, and
at least one of: occupancy use-data obtained from occupancy sensors in the building, the occupancy use-data at least indicating the presence or absence of a user at the multiple locations in the building, and daylight level use-data obtained from light sensors in the building, the daylight level use-data indicating an amount of incident daylight at the multiple locations in the building, and
computing energy-use prediction-data by evaluating the energy-use prediction model for the occupancy use-data and/or daylight level use-data, and
estimating the energy performance of the second lighting system compared to the first lighting system by comparing the energy-use use-data with the energy-use prediction-data.

2. A method as in claim 1, wherein the first and second lighting system are the same lighting system.

3. A method as in claim 2, comprising generating a signal if the energy-use use-data differs from the energy-use prediction-data by more than a threshold.

4. A method as in claim 1, comprising:
replacing the first lighting system with the second lighting system after the training period.

5. A method as in claim 4, comprising generating a signal if the energy-use use-data is more than the energy-use prediction-data.

6. A method as in claim 4, wherein
the occupancy training-data is obtained from occupancy sensors at first occupancy sensor locations in the building, the occupancy use-data is obtained from occupancy sensors at second occupancy sensor locations in the building, the first occupancy sensor locations being a subset of the second occupancy sensor locations, and/or
the daylight level training-data is obtained from light sensors at first light sensor locations in the building, the daylight level use-data is obtained from light sensors at second light sensor locations in the building, the first light sensor locations being a subset of the second light sensor locations.

7. A method as in claim 1, comprising:
receiving ambient light training-data and/or use-data from multiple ambient light sensors in the building and disaggregating the received ambient light training-data and/or use-data to obtain the daylight level training-data and/or the daylight level use-data.

8. A method as in claim 1, comprising:
receiving dimming level training-data and/or use-data from multiple luminaire in the first and/or second lighting system and computing the energy-use training-data and/or energy-use use-data therefrom.

9. A method as in claim 1, wherein the occupancy training-data, daylight level training-data, energy-use training-data, occupancy use-data, daylight level use-data, end energy-use use-data are obtained for multiple points of time during multiple days of the training and use period.

10. A method as in claim 1, wherein the energy use training-data and/or energy-use use-data is measured, or wherein the energy-use training-data and/or energy-use use-data is estimated from the dimming levels of the luminaires of the lighting system.

11. A method as in claim 1, wherein estimating the energy performance of the second lighting system compared to the first lighting system comprises computing the difference between the energy-use use-data with the energy-use prediction-data.

12. An energy performance evaluation device arranged to estimate the energy performance of a second lighting system in a building compared to a first lighting system in the building, the energy performance evaluation device comprising:
a training interface arranged to obtain training-data of the first lighting system in the building, the training-data being obtained from using the first lighting system in the building over a training period, the training-data comprising:
energy-use training-data indicating the energy-use of the first lighting system, and
at least one of: occupancy training-data obtained from occupancy sensors in the building, the occupancy training-data at least indicating the presence or absence of a user at multiple locations in the building, and daylight level training-data obtained from light sensors in the building, the daylight level training-data indicating an amount of incident daylight at multiple locations in the building, and
a machine learning unit arranged to train an energy-use prediction model for the first lighting system from the training-data,
a use interface arranged to obtain use-data of the second lighting system in the building, the use-data being obtained from using the second lighting system in the building over a use period, the use period being after the training period, the use-data comprising:
energy-use use-data indicating the energy-use of the second lighting system, and
at least one of: occupancy use-data obtained from occupancy sensors in the building, the occupancy use-data at least indicating the presence or absence of a user at the multiple locations in the building, and daylight level use-data obtained from light sensors in the building, the daylight level use-data indicating an amount of incident daylight at the multiple locations in the building, and
an energy-use prediction unit arranged to compute energy-use prediction-data by evaluating the energy-use prediction model for the occupancy use-data and/or the daylight level use-data, and
an evaluating unit arranged to estimate the energy performance of the second lighting system compared to the first lighting system by comparing the energy-use use-data with the energy-use prediction-data.

13. A second lighting system comprising
multiple occupancy sensors arranged to obtain occupancy use-data, the occupancy use-data at least indicating the presence or absence of a user at multiple locations in the building, and/or
multiple daylight sensors arranged to obtain daylight level use-data, the daylight level use-data indicating an amount of incident daylight at the multiple locations in the building, and
an energy-use unit arranged to obtain energy-use use-data indicating the energy-use of the second lighting system, and
the energy performance evaluation device according to claim 12.

14. A computer program comprising computer program instructions arranged to perform the method according to claim 1 when the computer program is run on a computer.

15. A computer readable medium comprising the computer program as in claim 12.
